(19) United States
(12) Patent Application Publication
(10) Pub. No.: US 2026/0307542 A1
(43) Pub. Date: Oct. 8, 2026

(54) ADVANCED POWER ELECTRONIC CIRCUIT FOR FUEL CELL VEHICLES ENABLING INDEPENDENT COOLING OF VARIOUS SYSTEMS

(71) Applicant: FORD GLOBAL TECHNOLOGIES, LLC, Dearborn, MI (US)

(72) Inventors: Hans Guenter QUIX, Herzogenrath (DE); Jan MEHRING, Koeln (DE)

(73) Assignee: FORD GLOBAL TECHNOLOGIES, LLC, Dearborn, MI (US)

(21) Appl. No.: 19/715,493

(22) Filed: Jun. 22, 2026

Related U.S. Application Data
(62) Division of application No. 18/213,438, filed on Jun. 23, 2023, now Pat. No. 12,679,248.

(30) Foreign Application Priority Data
Jul. 1, 2022 (DE) 102022116476.4

(51) Int. Cl. B60L 58/33; B60L 58/40; H01M 8/04007; H01M 8/04029; H01M 8/04746

(52) U.S. Cl. CPC B60L 58/33; B60L 58/40; H01M 8/04029; H01M 8/04067; H01M 8/04768; B60L 2210/10; H01M 2250/20

(57) ABSTRACT

A cooling system for fuel cells includes at least one first and one second coolant circuit, wherein the first coolant circuit is configured for cooling the fuel cells and the second coolant circuit is configured for cooling electronic components for controlling the fuel cells. The second coolant circuit may also be configured to cool an electric drive system. The second coolant circuit may include a first partial coolant circuit and a second partial coolant circuit, wherein the first partial coolant circuit is arranged in the region of the electronic components for controlling the fuel cells and the second partial coolant circuit is arranged in the region of the electronic components of the electric drive system.

### CROSS-REFERENCE TO RELATED APPLICATIONS

This application is a division of U.S. application Serial No. 18/213,438 filed Jun 23, 2023, which claims foreign priority benefits under 35 U.S.C. § 119(a)-(d) to DE Application 10 2022 116 476.4 filed Jul 1, 2022, which are hereby incorporated by reference in their entirety.

### TECHNICAL FIELD

The disclosure relates to a cooling system for fuel cells, to a corresponding vehicle, and to a method for operating the cooling system.

### BACKGROUND

Electrically powered vehicles that draw energy from fuel cells are also referred to as FCEVs (fuel cell electric vehicles). The electrical energy is either used directly by an electric drive or is temporarily stored in a drive battery. FCEVs have numerous electronic components that are provided for controlling the electric drive system and for controlling the fuel cells. Said components are commonly cooled in a coolant circuit. This however has the disadvantage that the cooling of individual components cannot be adapted to the present requirements. Thus, under some circumstances, certain components are cooled when this is not required.

### SUMMARY

A first aspect of the disclosure relates to a cooling system having fuel cells, which cooling system has at least one first coolant circuit, having a first pump, and one second coolant circuit, wherein the first coolant circuit is arranged for the purposes of cooling the fuel cells and the second coolant circuit is arranged for the purposes of cooling electronic components for controlling the fuel cells and for the purposes of cooling electronic components of an electric drive system. The cooling system is characterized in that the second coolant circuit has a first partial coolant circuit and a second partial coolant circuit, wherein the first partial coolant circuit is arranged for the purposes of cooling the electronic components for controlling the fuel cells and the second partial coolant circuit is arranged for the purposes of cooling the electronic components of the electric drive system.

The cooling system according to the disclosure advantageously allows variable cooling of different electronic components. Here, in a manner dependent on the operating situation, particular components of the power electronics can be cooled, and energy for cooling other components can be saved.

The arrangement of the first cooling circuit for the purposes of cooling the fuel cells and of the second coolant circuit, or of the first and second partial coolant circuits, for the purposes of cooling electronic components means that the coolant circuits run in the respective region of said parts so as to be able to dissipate heat from these regions.

A first pump may be arranged in the first partial coolant circuit and a second pump is arranged in the second partial coolant circuit. The first partial coolant circuit and the second partial coolant circuit can thus each be operated using a dedicated pump. In this way, a coolant flow can be selectively provided in a partial coolant circuit in which cooling is required, whilst no cooling is implemented in the other partial coolant circuit. It is however also possible for a coolant flow to be provided in both partial circuits.

A first check valve may be arranged in the cooling system between the inlet of the first partial coolant circuit and that of the second partial coolant circuit. This advantageously counteracts a backflow of coolant from the second partial coolant circuit into the first partial coolant circuit, which could adversely affect the efficiency of the cooling.

A second check valve may be arranged in the cooling system between the outlet of the first partial coolant circuit and that of the second partial coolant circuit. This advantageously counteracts a backflow of coolant from the second partial coolant circuit into the first partial coolant circuit, which could adversely affect the efficiency of the cooling.

A throttle may be arranged in the first partial coolant circuit in the region of an energy distributing unit. The throttle is provided for adjusting the coolant flow in the first partial coolant circuit, such that all electronic components therein can advantageously be uniformly cooled.

In one or more embodiments, the first coolant circuit is a high-temperature circuit, and the second coolant circuit is a low-temperature circuit. The fuel cells reach significantly higher temperatures, and must therefore be cooled much more intensely, than the electronic components of the electric drive and of the fuel cell controller. The two cooling circuits are separate from one another. The heat is dissipated using dedicated coolers or heat exchangers.

A second aspect of the disclosure relates to a vehicle having fuel cells and an electric drive, which vehicle has a cooling system according to the disclosure. The advantages of the vehicle correspond to the advantages of the cooling system according to the disclosure.

A third aspect of the disclosure relates to a method for cooling various electric and electronic components associated with controlling a fuel cell, and electric and electronic components associated with controlling an electric drive according to the disclosure, having the steps: detecting the component temperatures in the first partial coolant circuit and in the second partial coolant circuit, activating the first pump if the component temperatures in the first coolant circuit exceed a threshold value, and activating the second pump if the component temperatures in the second coolant circuit exceed a threshold value. The advantages of the method correspond to the advantages of the cooling system according to the disclosure.

In one or more embodiments, the cooling system is operated in a first operating state when, in the method, the first pump is driven and the second pump is not. In this case, the first partial coolant circuit is operated. In a second operating state, the second pump is driven and the first pump is not. In this case, the second partial coolant circuit is operated. In a third operating state, the first pump and the second pump are both driven. In this case, both partial circuits are operated.

### BRIEF DESCRIPTION OF THE DRAWINGS

FIG. 1 is an illustration of an embodiment of a cooling system according to the disclosure.

FIG. 2 shows the embodiment according to FIG. 1 in a first operating state.

FIG. 3 shows the embodiment according to FIG. 1 in a second operating state.

FIG. 4 shows a flow diagram of an embodiment of the method according to the disclosure.

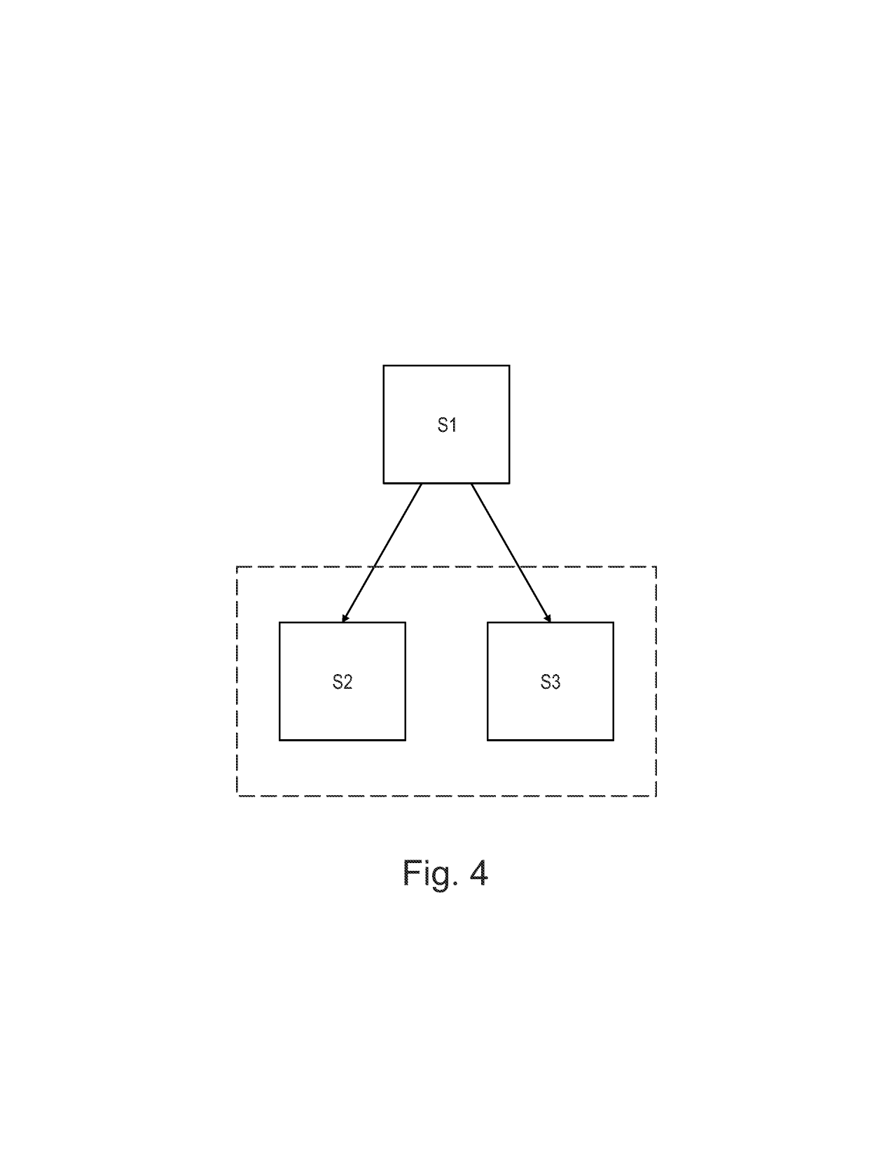

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

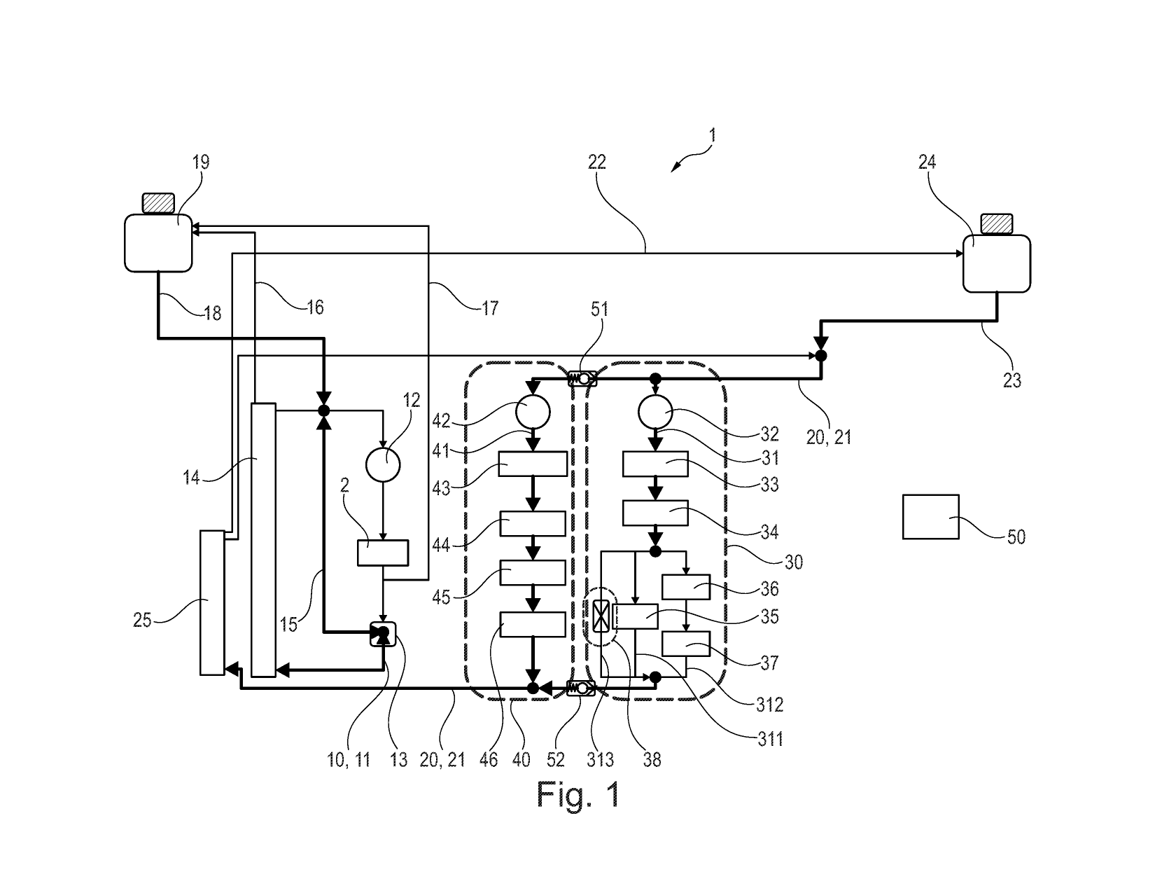

FIG. 1 illustrates an arrangement of a cooling system 1 according to the disclosure. The cooling system 1 is arranged having fuel cells 2. The fuel cells 2 serve for generating electrical energy that is provided to an electric drive. The fuel cells 2 are cooled by a first coolant circuit 10.

The first coolant circuit 10 is a high-temperature circuit. In the first coolant circuit 10, the coolant flows through a first coolant line 11. Here, the coolant is conveyed by a first pump 12. A three-way valve 13 with a temperature sensor, in other words a temperature-dependent three-way valve, is arranged in the first coolant line 11 downstream of the fuel cells 2. In a manner dependent on the temperature of the coolant, said coolant can be conducted through a first cooling radiator 14 or through a bypass line 15 past the first cooling radiator 14, which bypass line opens into the first coolant line 11 again downstream of the first cooling radiator 14. The first coolant circuit 10 is connected via a first expansion line 16, a second expansion line 17 and a third expansion line 18 to a first expansion tank 19.

Numerous electronic components are arranged in the vehicle for the purposes of controlling the fuel cells 2 and the electric drive. These electronic components are cooled by a second coolant circuit 20. The second coolant circuit 20 runs through a second coolant line 21 and is connected via a fourth expansion line 22 and a fifth expansion line 23 to a second expansion tank 24. The second coolant line 21 runs through a second cooling radiator 25. As per the illustration in FIG. 1, the second coolant line 21 branches upstream of the electronic components into two partial circuits, specifically a first partial coolant circuit 30 and a second partial coolant circuit 40. The two partial circuits 30, 40 are indicated in FIG. 1 by a respective dashed line.

The first partial coolant circuit 30 runs in the region of the electronic components that are provided for controlling the fuel cells 2. Arranged in a first partial coolant line 31 is a second pump 32 that conveys the flow of the coolant in the first partial coolant circuit 30. Downstream of the second pump 32 (in relation to the first partial coolant line 31), there are arranged a DC voltage converter for the fuel cell 33, a DC voltage converter for the battery 34, a power distributor unit for the fuel cell 35, a compressor control device 36, and an electrical compressor 37. Downstream of the DC voltage converter for the battery 34, the first partial coolant circuit 30 branches into three sections, such that the power distributor unit for the fuel cell 35 is arranged in a first section 311, and the compressor control device 36 and the electrical compressor 37 are arranged in a second section 312. Arranged in a third section 313 is a throttle device 38 that serves for throttling the coolant flow. Downstream of said devices, the sections 311, 312 and 313 merge again to form the first partial coolant line 31.

The second partial coolant circuit 40 runs in the region of the electric drive of the vehicle and of the electronic components for controlling the electric drive.

Arranged in a second partial coolant line 41 is a third pump 42 that conveys the flow of the coolant in the second partial coolant circuit 40. Downstream of the third pump 42, there are arranged a charging unit 43, a high voltage/low voltage DC voltage converter 44, an inverter 45, and an electric motor 46.

A first check valve 51 is arranged downstream of the point at which the first partial coolant line 31 branches from the second coolant line 21, or in other words at which the second coolant line 21 branches into the first partial coolant line 31 and second partial coolant line 41. A second check valve 52 is arranged upstream of the point at which the first partial coolant line 31 opens into the second partial coolant line 41 to form the second coolant line 21. The check valves 51, 52 serve for controlling the flow such that it is possible to prevent operation of the first partial coolant circuit 31 when the second partial coolant circuit 41 is operated.

The pumps 12, 32, 42 are controlled by a control device 50. In the embodiment shown, the pumps 32 and 42 are of the same type, that is to say the pressure loss in the two partial coolant circuits 30 and 40 is approximately equal. If only the second pump 32 is active, then the first check valve 51 is automatically closed. It is thus not possible for any coolant to be "drawn in" from the partial coolant circuit 40. If only the third pump 42 is active, then the second check valve 52 is automatically closed. If both pumps 32, 42 are running, then both valves 51, 52 are open. If, for example in other embodiments, the pressure losses in the partial coolant circuits 30 and 40 are different, and pumps 32, 42 of different power are installed, it could be necessary for the valves 51 and 52 to be differently "tuned", for example with different cross sections and spring rates.

As coolant, a water-glycol mixture, or some other expedient coolant with which a person skilled in the art is familiar, is used in both circuits 10, 20.

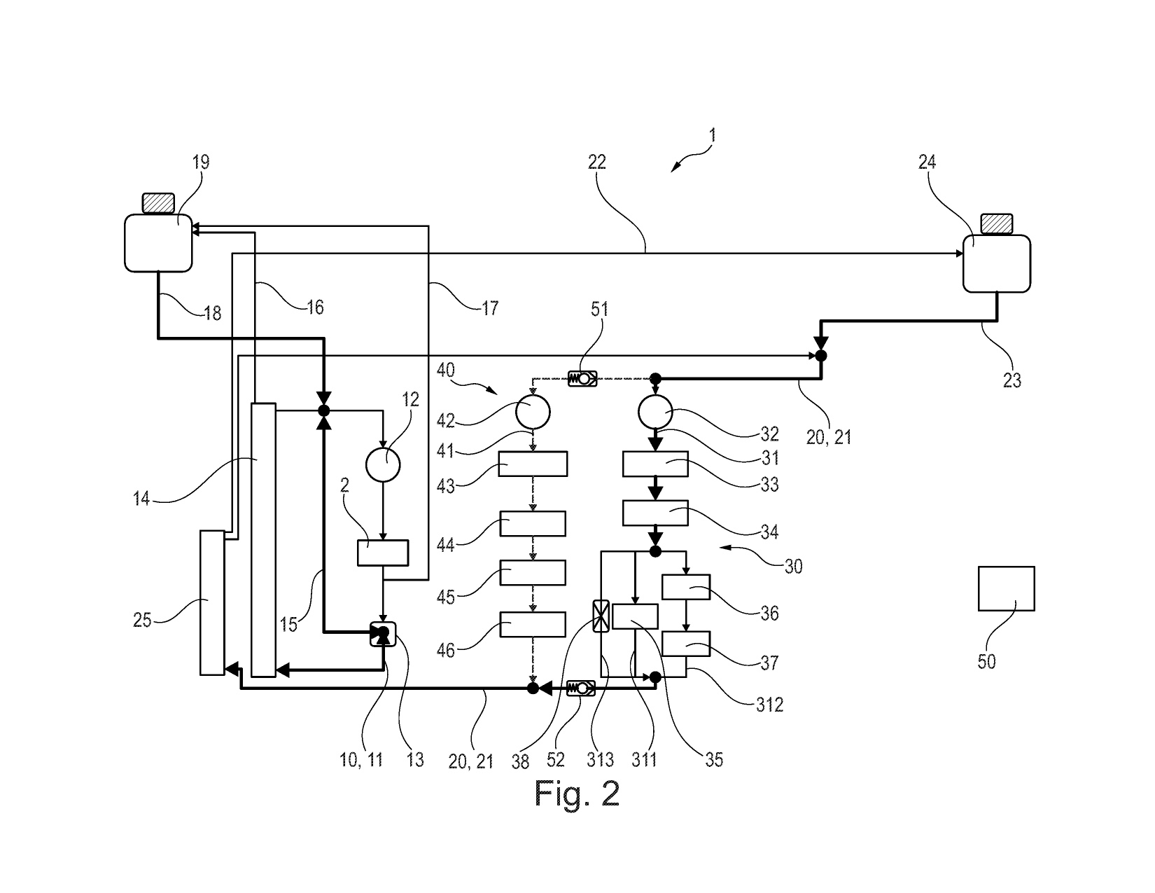

FIG. 2 shows the cooling system 1 according to the disclosure in a first operating state in which the components of the first partial coolant circuit 30 are being cooled (indicated by a solid line for the first partial coolant line 31 and a dashed line for the second partial coolant line 41). The first operating state is implemented if only the electronic components provided for controlling the fuel cells 2 require cooling. For this purpose, the second pump 32 is activated by way of a signal from the control device 50. The third pump 42 remains inactive, such that no coolant flows through the second partial coolant circuit 40.

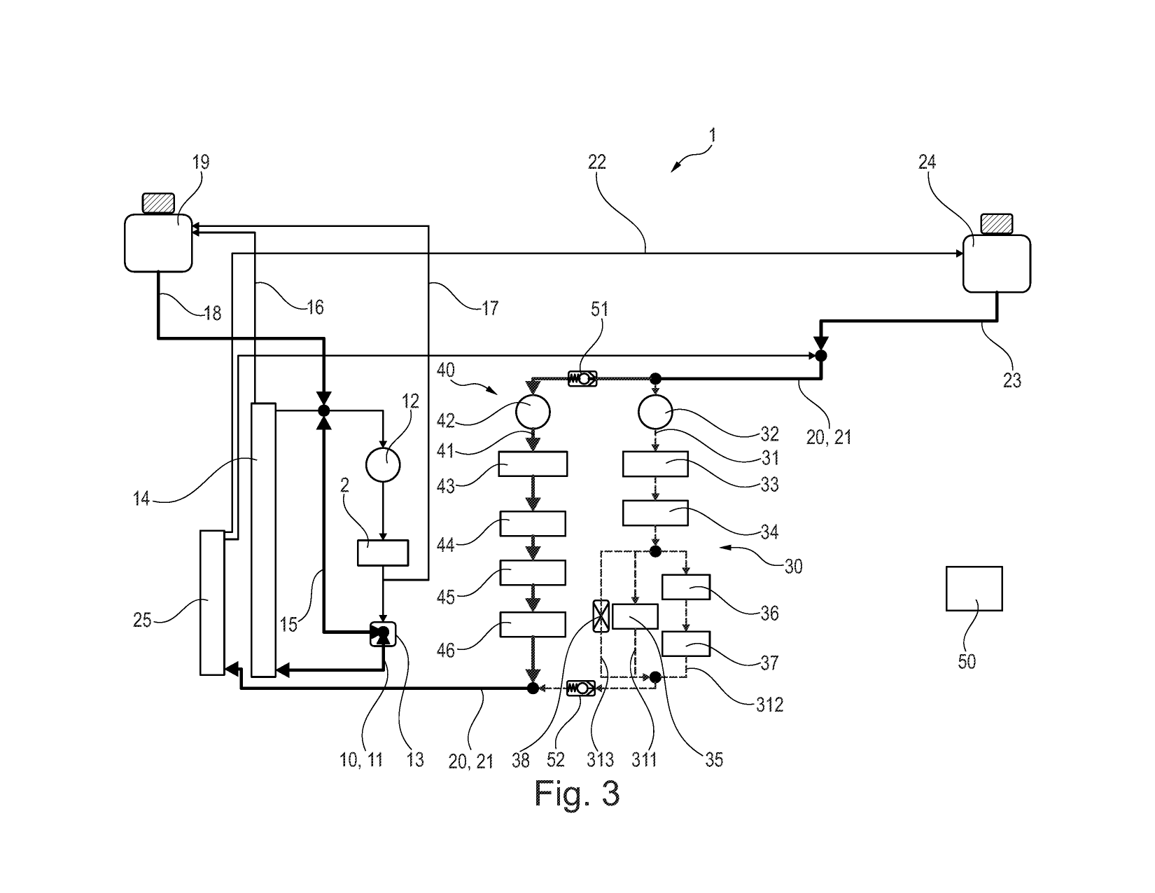

FIG. 3 shows the cooling system 1 according to the disclosure in a second operating state in which the components of the second partial coolant circuit 40 are being cooled (indicated by a solid line for the second partial coolant line 41 and a dashed line for the first partial coolant line 31). The second operating state is implemented if only the electric drive and the electronic components correspondingly provided for controlling same require cooling. For this purpose, the third pump 42 is activated by way of a signal from the control device 50. The second pump 32 remains inactive, such that no coolant flows through the first partial coolant circuit 30.

FIG. 1 corresponds to a third operating state of the cooling system 1 according to the disclosure, in which flow passes through both partial coolant circuits 30, 40. The third operating state is implemented if both the electronic components provided for controlling the fuel cells require cooling and the electric drive and the electronic components correspondingly provided for controlling same also require cooling. For this purpose, the second pump 32 and the third pump 42 are correspondingly activated by way of a signal from the control device 50.

In a method for cooling components, a cooling system 1 according to FIG. 1, in a first step S1, the temperatures of the components in the first partial coolant circuit 30 and in the second partial coolant circuit 40 are detected. In a second step S2, the second pump 32 is activated if the component temperatures in the first partial coolant circuit 30 exceed a threshold value. In this case, the first operating state of the cooling system 1 is activated.

In a third step S3, the third pump is activated if the component temperatures in the second partial coolant circuit 40 exceed a threshold value. In this case, the second operating state of the cooling system 1 is activated.

Steps S2 and S3 take place at the same time. Here, the third operating state of the cooling system 1 may also be activated if the component temperatures in the first partial coolant circuit 30 and in the second partial coolant circuit 40 exceed a threshold value. For this purpose, the second pump 32 and the third pump 42 are activated.

While representative embodiments are described above, it is not intended that these embodiments describe all possible forms of a cooling system, electrified vehicle, or method of controlling a cooling system according to the disclosure. The words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A coolant system comprising:
a high-temperature coolant circuit having a first pump, a first radiator, and a temperature-dependent three-way valve, the valve arranged in a first coolant line downstream of at least one fuel cell and operable to selectively route coolant to bypass the first radiator when coolant temperature is below a predetermined threshold, the high-temperature coolant circuit connected via first, second, and third expansion lines to a first expansion tank, the high-temperature coolant circuit routing coolant through the at least one fuel cell; and
a low-temperature coolant circuit having a second pump and a second radiator, the low-temperature coolant circuit connected via fourth and fifth expansion lines to a second expansion tank, the low-temperature coolant circuit routing coolant through first control electronics associated with the at least one fuel cell and second control electronics associated with an electric machine.

2. The coolant system of claim 1 wherein the low-temperature coolant circuit includes a first partial coolant circuit configured to route coolant through the first control electronics and a second partial coolant circuit configured to route coolant through the second control electronics.

3. The coolant system of claim 2 wherein the second pump is disposed within the first partial coolant circuit, the coolant system further comprising:
a third pump disposed within the second partial coolant circuit;
a first check valve disposed between an inlet of the first partial coolant circuit and an inlet of the second partial coolant circuit;
a second check valve disposed between an outlet of the first partial coolant circuit and an outlet of the second partial coolant circuit; and
wherein the second partial coolant circuit includes a first branch and a second branch both disposed downstream of the third pump, the coolant system further comprising a throttle disposed within the second branch, wherein the first branch is configured to cool fuel cell power distributor electronics.

4. The coolant system of claim 3 wherein the first partial coolant circuit circulates coolant to a DC voltage converter for at least one fuel cell, a DC voltage converter for a vehicle traction battery, power distribution electronics for the at least one fuel cell, a compressor controller, and an electrical compressor of an electrified vehicle.

5. The coolant system of claim 4 wherein the high-temperature coolant circuit includes a three-way bypass valve that bypasses the first radiator responsive to coolant temperature being below a predetermined temperature.

6. A coolant system comprising:
a higher-temperature coolant circuit routing coolant through at least one fuel cell, the higher-temperature coolant circuit including a first pump, a first radiator, and a temperature-dependent three-way valve, the valve arranged in a first coolant line downstream of the at least one fuel cell; and
a lower-temperature coolant circuit routing coolant through first control electronics associated with the at least one fuel cell, the lower-temperature coolant circuit having a second pump and a second radiator.

7. The coolant system of claim 6 further comprising a first expansion tank connected by a plurality of expansion lines to the higher-temperature coolant circuit.

8. The coolant system of claim 7 wherein the plurality of expansion lines comprises first, second, and third expansion lines connecting the higher-temperature coolant circuit to the first expansion tank.

9. The coolant system of claim 7 further comprising a second expansion tank connected by a second plurality of expansion lines to the lower-temperature coolant circuit.

10. The coolant system of claim 9 wherein the second plurality of expansion lines comprises fourth and fifth expansion lines connecting the second expansion tank to the lower-temperature coolant circuit.

11. The coolant system of claim 6 wherein the higher-temperature coolant circuit comprises a first pump and a first radiator, and wherein the temperature-dependent three-way valve is operable to selectively route coolant to bypass the first radiator when coolant temperature is below a predetermined threshold.

12. The coolant system of claim 11 wherein the lower-temperature coolant circuit comprises a second pump and a second radiator, the second pump configured to circulate coolant through the lower-temperature coolant circuit.

13. The coolant system of claim 12 wherein the lower-temperature coolant circuit includes a first partial coolant circuit configured to route coolant through the first control electronics and a second partial coolant circuit configured to route coolant through second control electronics associated with an electric machine.

14. The coolant system of claim 13 wherein the second pump is disposed within the first partial coolant circuit, the coolant system further comprising:
a third pump disposed within the second partial coolant circuit;
a first check valve disposed between an inlet of the first partial coolant circuit and an inlet of the second partial coolant circuit;
a second check valve disposed between an outlet of the first partial coolant circuit and an outlet of the second partial coolant circuit; and
wherein the second partial coolant circuit includes a first branch and a second branch both disposed downstream of the third pump, the coolant system further comprising a throttle disposed within the second branch, wherein the first branch is configured to cool fuel cell power distribution electronics.

15. The coolant system of claim 14 wherein the first partial coolant circuit circulates coolant to a DC voltage converter for at least one fuel cell, a DC voltage converter for a battery, and power distribution electronics for the at least one fuel cell.
